(19) United States
(12) Patent Application Publication
(10) Pub. No.: US 2022/0389872 A1
(43) Pub. Date: Dec. 8, 2022

(54) ADDITIVELY MANUFACTURED GAS TURBINE FUEL INJECTOR RING AND UNI-BODY TURBINE ENGINE

(71) Applicant: Sierra Turbines Inc., San Jose, CA (US)

(72) Inventors: Roger C. Smith, Cupertino, CA (US); David E. Laudermilch, Wesby, WI (US)

(21) Appl. No.: 17/384,706

(22) Filed: Jul. 23, 2021

Related U.S. Application Data
(60) Provisional application No. 63/055,341, filed on Jul. 23, 2020.

(51) Int. Cl. F02C 7/22

(52) U.S. Cl. CPC F02C 7/22; F05D 2240/35

(57) ABSTRACT

A micro-turbine core fabricated as a single part using 3D additive manufacturing (AM) to simultaneously form sequential layers of at least two static components from any of the following static components: central bearing support structure, outer casing, combustor complete, nozzle guide vanes (NGVs), diffuser, diffuser outer casing, fuel manifold, fuel injector(s), igniter mounting boss, oil manifold, oil distribution lines, or turbine outer casing. The single part does not require fastening hardware, welding, and/or bonding processes to create the single part.

### CROSS-REFERENCE TO RELATED APPLICATIONS

This application claims priority to provisional application(s): Ser. No. 63/055,341 filed 23 Jul. 2020, titled “ADDITIVELY MANUFACTURED GAS TURBINE FUEL INJECTOR RING AND UNI-BODY TURBINE ENGINE,” the disclosures of said application is incorporated by reference herein in its entirety. Furthermore, where a definition or use of a term in a reference, which is incorporated by reference herein, is inconsistent or contrary to the definition of that term provided herein, the definition of that term provided herein applies and the definition of that term in the reference does not apply.

### FIELD OF TECHNOLOGY

This disclosure relates generally to the technical field of gas turbines, and in one example embodiment, this disclosure relates to a method, apparatus and system of additively manufactured gas turbine components including but not limited to the combustor, fuel injector, circumferential injector and engine core individually or any combination thereof.

### BACKGROUND

Additive Manufacturing (AM) of components and assemblies is an alternative to traditional manufacturing methods such as casting, milling, manual and computer numerical control (CNC) machining, etc. AM technology has been used mainly for prototyping due to existing equipment limitations and limited mature software tools. Typically, AM is used for individual piece parts with a single material and consistent material properties such as density, porosity, surface finish, tolerances, etc. In a system or an assembly, often times a complex individual part is made by AM, and incorporated into a housing, with other piece parts that are manufactured using traditional methods and materials.

Assembling and joining the mixture of traditional parts and AM parts is typically accomplished using conventional fastening and joining technologies, such as welding, riveting, fastening, and the like. This allows a frugal use of expensive AM manufacturing where necessary, on the complex specialty part.

Three-dimensional (3D) printing of metal parts is accomplished by the use of powdered metal and high-power lasers to melt the metal in thin layers of narrow laser beam patterns that gradually build up the 3D part. The size of the parts is typically limited by the 3D printer table size and fabrication envelope.

Gas and jet turbines are complicated machines with a wide variety of components that in turn require a wide range of strengths, tolerance, temperature capabilities, surface finishes, functions, shapes, and other material properties. Conventional applications of AM 3D printing for turbines can include limited applications of a combustor liner and or a turbine nozzle, for example. Both these parts serve a function as a housing and typically do not require precision tolerances and complicated shape features. Since the function and application of these two parts, individually and together, is reasonably consistent, they are a good candidate for AM. However, the balance of components in a turbine has inconsistent functions, tolerances, feature size complexity, etc. that might not make them an ideal application for AM, either separately or together.

One specialty area of function for the turbine is the fuel injector and the combustor. The fuel injector is a specialty device used to deliver fuel to the combustor for ignition. Fuel injectors are traditionally discrete independent devices installed at discrete locations around a circumference of the turbine core. Because of the discrete locations, combustion of injected fuel tends to form a cylindrical flame propagation disposed axially from each discrete fuel injector. The concentrated combustion may create thermal gradients around the circumference of the combustor.

Additionally, atomization of the jet petroleum (JP) fuel within the combustor to miniscule drops is important for complete combustion of the fuel and attainment of maximum possible thrust from the turbine. Consequently, precision tolerances and finish of discrete fuel injectors is important to achieve the desired atomization.

The remaining components of a turbine have similar unique and differing functions and physical property requirements. This often makes their manufacturing process unique to them, which thereby proliferates part count and unique material processing techniques. Finally, the assembly of these parts is typically time consuming and can result in inventory, maintenance, and rework headaches.

### BRIEF SUMMARY

This disclosure describes design for Additive Manufacturing (DFAM) of a uni-bodied micro turbine engine. The design utilizes AM machine capability to release design intent and works around machine limitations found on existing Laser Powder bed AM equipment. A uni-bodied assembly, that was designed for AM manufacturing, and that takes into account the benefits of geometries that are not possible via casting, or traditional subtractive machining operations, would thus represent a novel idea for producing products.

In one embodiment, a turbine core is a single unibody part comprising at least two static components of: a central bearing support structure, an outer casing, a combustor, a plurality of nozzle guide vanes (NGVs), a diffuser section, a diffuser outer casing, a fuel manifold, a circumferential fuel injector, an igniter mounting boss, a fuel-lubricating-manifold, a fuel-lubricating-port, or a turbine outer casing. The single unibody part does not require fastening hardware or welding processes, e.g., electron-beam, spot welding, etc., to couple the at least two static components like conventional construction uses. By avoiding fasteners, the related safety wire is not needed and foreign object damage (FOD) is less likely. The turbine core of the single unibody part is created solely by a 3D additive manufacturing process for functional operation of sustaining combustion, though additional conventional add-ons can be independently fabricated and conventionally fastened thereto, e.g., a fuel pump, a controller, etc. Examples combinations of static components that are a single unibody part include NGVs, combustor, and bearing support structure; or combustor and igniter mounting boss; or diffuser section and diffuser outer casing; or fuel-as-lubricant manifold and fuel-as-lubricant port, etc. Further integration of these combinations of static components can be made as a single unibody part.

Some of the combinations of static components that are fabricated as a single unibody part have different porosities that are inconsistent with each other. For example, the combustor and the circumferential fuel injector are fabricated simultaneously with each other to form the single unibody part but have different porosity, density, and/or surface finish requirements. The former is a smooth continuous surface finish (with holes) of solid metal with high temperature capabilities, while the latter is a porous and discontinuous 3D matrix that does not require the same high temperature capabilities. Yet, those two static components are fabricated as a single unibody part of the same material, and done so simultaneously, i.e., a layer of powdered metal is deposited and lased to build up a layer of both components simultaneously. It is the location-specific lasing operation that determines the power, dwell-time, pattern, porosity, etc. desired for a given component portion of the given layer of the single unibody part is being built, and thereby allowing simultaneous fabrication. For example, as the laser scans across an x-axis location for a given z-axis layer, it will encounter, at the outer dimensions, the outer casing of the turbine, then typically the combustor wall, then depending on the layer, the circumferential fuel injector matrix of latticed strands, and then the inner structural tunnel. After passing a midplane, the process repeats itself in the opposite sequence, all the while tailoring the location-specific lasing operation.

In one embodiment, the single unibody part comprises all of the static components that are all made of the same material, albeit with some variation in physical properties such as surface finish, density, and continuity as controlled by the powdered metal and the lasing power, duration, and pattern. A single unibody part reduces inventory, simplifies production, and provides a one-stop-shop for the turbine core.

Because static components are fabricated simultaneously, they are inherently coupled. A primary example is the combustor being rigidly coupled to a front face and a rear face of the turbine core in the present embodiment.

The most specialized component is the circumferential fuel injector, which is formed as a microscopic lattice structure integral with the turbine core. The unique properties of the fuel injector include a continuous injector source of fuel that spans radially and circumferentially across the circumferential fuel injector surface area. This provides a homogenous and consistent source of fuel throughout the combustor. This avoids discontinuous hot spots/regions associated with individual injector nozzles or heads, which tend to be circular and which tend to create multiple parallel cylinder shapes of combustion. Thus, the single unibody turbine core does not require one or more discrete and individually manufactured and installed injectors, in order to deliver fuel to the combustor.

In one embodiment, the circumferential injector comprises a continuous circumferential face, both circumferentially and radially, that is coupled to a pressurized fuel manifold. The coupling is a simultaneous co-forming or fabrication of the injector and the fuel manifold, so the parts are a single unibody construction. The fuel manifold is sealed except for the fuel injector interface, which receives transfers, preheats, and/or atomized the fuel into reduced-size droplets or mist particles for efficient combustion in the combustor. Continuous means there is no intentional locus of function or hardware, but rather the function is spread out evenly and consistently across the given component. Specifically, a plurality of pores formed radially and circumferentially within the continuous circumferential face communicates the fuel from a pressurized fuel manifold into the combustor. In one embodiment, the circumferential injector comprises a continuous matrix of latticed strands disposed in at least two dimensions of circumferential, radial, and axial. The latticed strands have a porosity to receive fuel from a high-pressure fuel manifold to atomize fuel dispensed from pore openings into the combustor. The continuous matrix is a three-dimensional (3D) graded stochastic lattice structure in the present embodiment. Thus, the injector is not required to be a single specific pore size across the entire circumferential injector. Rather, it is a controlled range of pore sizes and lattice structures that on average creates a consistent delivery function of fuel droplet/mist to the combustor.

The circumferential fuel injector can be fabricated in one embodiment as a 3D AM separate part for installation in a conventionally designed and built turbine core. This stand-alone circumferential fuel injector would include attachment features such as flanges, seals, mounting surfaces, or etc. that are typically required for conventional assembly with other parts to form the turbine unit. Thus, the combustor efficiency and uniform combustion properties can be obtained in both a turbine core formed from a single unibody part or from a conventional assembly process of discrete components.

At least one of a fuel supply line and a fuel-lubricating manifold are co-formed in the single unibody part, and in one embodiment, all the fuel lines and lubricating lines are formed integrally with the turbine core. This feature eliminates installation and service problems, and it provides a more reliable routing of fuel, both as a combustion product as well as a lubricant. An added benefit of this design and manufacture is that fuel is preheated in at least one of a fuel line inlet, fuel line passageway, fuel supply rail and/or fuel manifold, one or more of which are integrally formed with a turbine housing. Furthermore, the integrated fuel and lubricating lines can be tapped into at multiple locations along its path, as needed for design changes or application needs.

The benefits of the aforementioned design, components, and fabrication methodology of a single unibody turbine core include lower cost, lower labor, lower time-to-manufacture, more precision, higher reliability and longer life. Additionally, design iterations are faster and less expensive because software changes replace tooling changes. The net result is a faster time to market with more customization and adaptation of design features for given applications.

This Summary is provided to introduce a selection of concepts in a simplified form that are further described below in the detailed description section. This summary is not intended to identify key or essential features of the claimed subject matter, nor is it intended to be used as an aid in determining the scope of the claimed subject matter.

### BRIEF DESCRIPTION OF THE DRAWINGS

Example embodiments are described by way of illustrations and are not limited by the figures of the accompanying drawings, wherein:

FIG. 1A is an isometric exploded view with a cutaway section of a uni-body construction micro-turbine, according to one or more embodiments.

FIG. 1B is a cross-section of a side view of a uni-body construction micro-turbine, according to one or more embodiments.

FIG. 1C is a block diagram illustrating a uni-body construction micro-turbine powering either a generator or a propeller, according to one or more embodiments.

FIG. 2A is a cutaway view of a uni-body construction micro-turbine showing a fuel inlet, a fuel supply rail, a fuel distributor inlet, a fuel manifold, and a fuel-lubricating manifold and fuel-lubricating port, according to one or more embodiments.

FIG. 2B is a cutaway view of a uni-body construction micro-turbine showing a fuel supply rail to fuel distributors supplying the circumferential injector ring, according to one or more embodiments.

FIG. 2C is a cutaway view of a uni-body construction micro-turbine showing a circumferential injector ring, partially exposed without supporting fuel manifold and fuel distributors, according to one or more embodiments.

FIG. 2D is a cutaway section of a uni-body construction micro-turbine with a detail view of graded stochastic lattice structure of the circumferential injector ring, according to one or more embodiments.

FIG. 2E is a cross-sectional side view of a circumferential fuel injector with an inverse stochastic gradient of strands for breaking up and atomizing fuel, according to one or more embodiments.

FIG. 2F is a top view of four different exemplary patterns formed by strands in the circumferential injector ring matrix, according to one or more embodiments.

FIG. 2G is an aft view looking into the exhaust of the uni-body construction micro-turbine, with portions of the circumferential injector ring matrix visible between the nozzle guide vanes, according to one or more embodiments.

FIG. 3A is a graph of probable droplet size versus pore diameter at hot and cold temperatures, according to one or more embodiments.

FIG. 3B is a graph of estimated spray angle versus pore diameter, according to one or more embodiments.

FIG. 3C is an illustration for calculating atomization design parameters, according to one or more embodiments.

FIG. 4 is an isometric view of evenly distributed discrete fuel heads at a front of the combustion chamber, according to one or more embodiments.

FIG. 5A is a flowchart of a process to translate an engineering design into an additive manufacturing operation for a uni-body construction micro-turbine, according to one or more embodiments.

FIG. 5B is a flowchart of a process to manufacture a uni-body construction micro-turbine with a circumferential injector ring via additive manufacturing, according to one or more embodiments.

FIG. 5C is a flowchart 500-C of a process to atomize fuel through a circular fuel injector, according to one or more embodiments.

The drawings referred to in this description should be understood as not being drawn to scale, except if specifically noted, in order to show more clearly the details of the present disclosure. Same reference numbers in the drawings indicate like elements throughout the several views. Other features and advantages of the present disclosure will be apparent from accompanying drawings and from the detailed description that follows.

### DETAILED DESCRIPTION AND MODE OF IMPLEMENTATION

The engine herein described was designed to be additively manufactured in the orientation shown to minimize post processing from the build plate. It is designed to be self-supporting as the individual layers are built.

Additive manufacturing is sometimes referred to as 2.5D and works by sweeping a laser beam across the X-Y plane to sinter powder in the location of the part being constructed. When a layer is complete, the build plate is moved in the Z direction (print direction). Since the part is welded to the build plate initially and has to be removed later, any design that minimizes the supports that have to be added where there is a void (to support a layer above it), can be impossible to remove if the component is enclosed. Furthermore, on systems that use a recoater blade, thin walls (less than 1 mm) have high failure rates due to frictional interaction with the blade.

Further when building components in difficult to weld metal powders due to high laser power and melt pool gradients—the design takes advantage of the non contact recoater blade to create high aspect geometries, for example thin wall lattices.

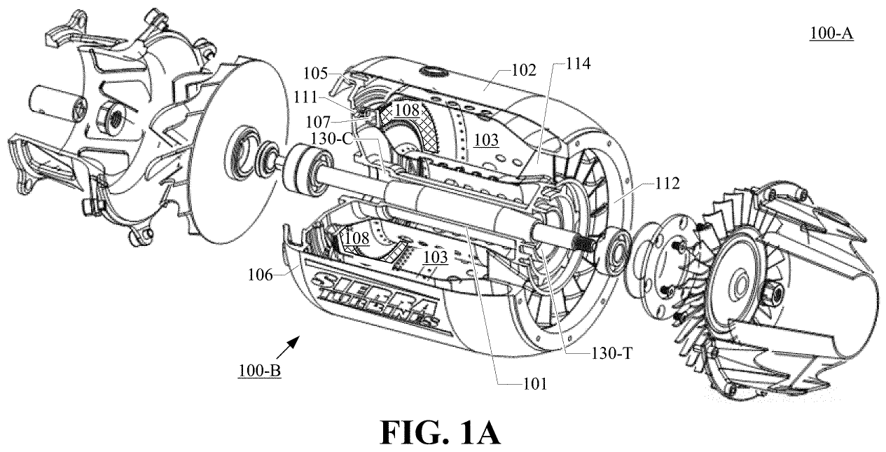

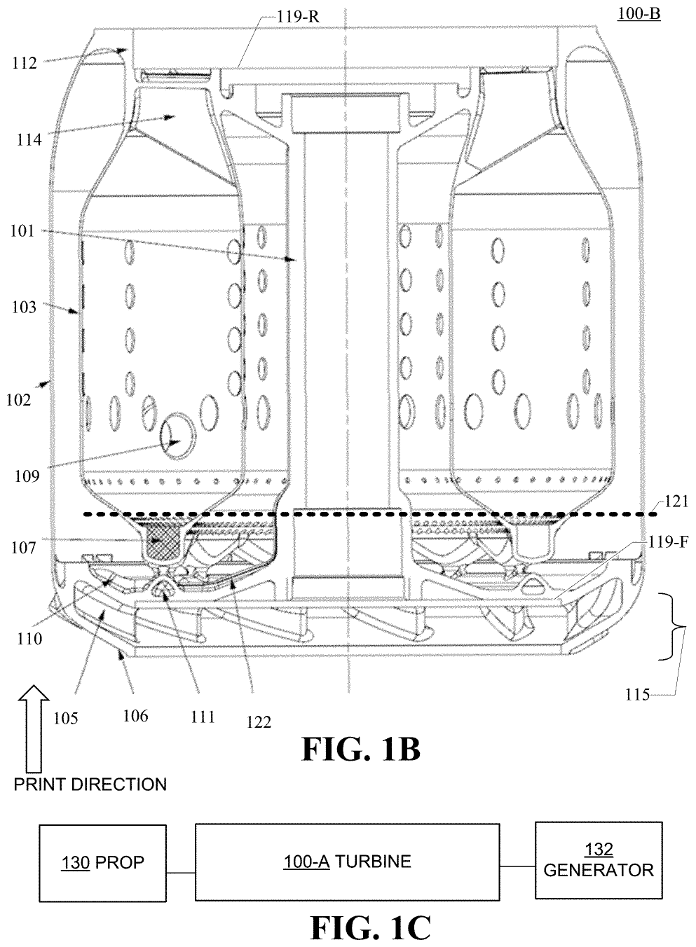

Referring now to FIG. 1A, an exploded view is shown with a cutaway section of a uni-body, aka unibody, construction micro-turbine 100-A, according to one or more embodiments. Components labeled herein are described in subsequent FIG. 1B. Additional rotating components necessary to create a fully functional gas micro-turbine include a compressor, a main shaft and bearings, a turbine, as well as the mating components such as inlet housing, exhaust nozzle, and attachment hardware

Referring now to FIG. 1B, a cross-section of a side view is shown of a uni-body construction micro-turbine, according to one or more embodiments. A single part 100-B comprises all the static components of a micro-turbine core. That is, one single part fabricated with AM and no joining seams or attachments, performs the functions of at least the following static components, or parts, commonly found in today's state-of-the-art-microtubines: a central bearing support structure 130, an outer casing 102, a combustor 103, a plurality of nozzle guide vanes (NGVs) 114, a diffuser section 115, a diffuser outer casing 106, a fuel manifold 107, a circumferential fuel injector 108, an igniter mounting boss 109, an oil manifold (aka fuel-as-lubricant manifold) 122, one or more distribution lines (aka, fuel-as-lubricant ports) 120, a turbine outer casing 102. In the present embodiment, all the surfaces, features, and functions shown in the present figure are fabricated into a single uni-body turbine core. These can include a Inner structural tunnel 101, front and rear face of turbine 119-F, 119-R, plurality of diffuser vanes 105, fuel line passageway 110, fuel supply rail 111, fuel distributors 113, fuel inlet 117, fuel supply line 118, turbine abradable liner 112, and other features and functions shown and used for gas turbine operation, despite not being explicitly pointed out herein.

In one embodiment, all internal static components of micro-turbine are 3D AM fabricated as non-serviceable features and integral components. Uni-body construction micro-turbine 100-B includes at least one of front and rear face of turbine 119-F, 119-R as a base and support for 3D AM fabricating any subsequent desired components in the print direction. An opposing face of micro-turbine can be either 3D AM fabricated to enclose the micro-turbine, or it can be installed as a separately manufactured piece part, using conventional attachment and fastening techniques, such as EBW.

In another embodiment, one or more of the functional components shown can be manufactured separately and attached thereto. For example, a modified embodiment is a uni-body microturbine shown minus a diffuser section, with a separately manufactured diffuser section attached thereto using conventional means. The same philosophy can be used for other components that are easily appended to a less-than-complete unit-body microturbine, such as the nozzle guide vanes, etc. Despite a less-than-complete unit-body microturbine, a vast majority of the structures and features are still combinable into a single unit-body construction.

In yet another embodiment, any combination of two or more of these static components can be fabricated to make subassemblies, and then assembled using conventional techniques. In another embodiment, all parts shown in the present figure are formed as a single uni-body turbine core.

A single part means a continuous structure. In one embodiment, there are no split lines arising from subsequent assembly of individually fabricated parts that then require fasteners to join said individual separate piece parts together to form an assembly to create a single final part (or assembly). In another embodiment, there is no requirement for welding (TIG, MIG, spot, electron beam (EBW), etc.), fusing, diffusion bonding, etc. to join or attach individual separate piece parts that were previously fabricated as separate elements, together to form an assembly that appears to be a single piece.

In comparison, a unibody shell, e.g., a traditional passenger vehicle, fabricates separate panels then spot-welds them together to create a single unit that is inseparable without destructive methods. In the present embodiment, the uni-body micro-turbine is a continuous flow of material that is formed simultaneously (one section layer at a time). Thus, there are no seams or weld joints in the uni-body micro-turbine. Attachment points, such as lugs, bosses, flanges, etc., can be formed in the unit-body microturbine for attachment of external hardware.

In the present embodiment, the single uni-body turbine core is comprised of a single common material, such as Hastelloy X, Inconel 718, RENE-80, or any other material with sufficient strength for the thrust or horsepower rating of the turbine, sufficient high-temperature thermal capabilities, sufficient fatigue properties, and other sufficient physical properties necessary for this application.

104 MISSING Define;

[symbol]

Referring now to FIG. 1C, a block diagram is shown illustrating a uni-body construction micro-turbine powering either a generator or a propeller, according to one or more embodiments. The present uni-body construction micro-turbine is well suited for an inline directly powered or a free-turbine turboshaft application, with a commensurate power demand.

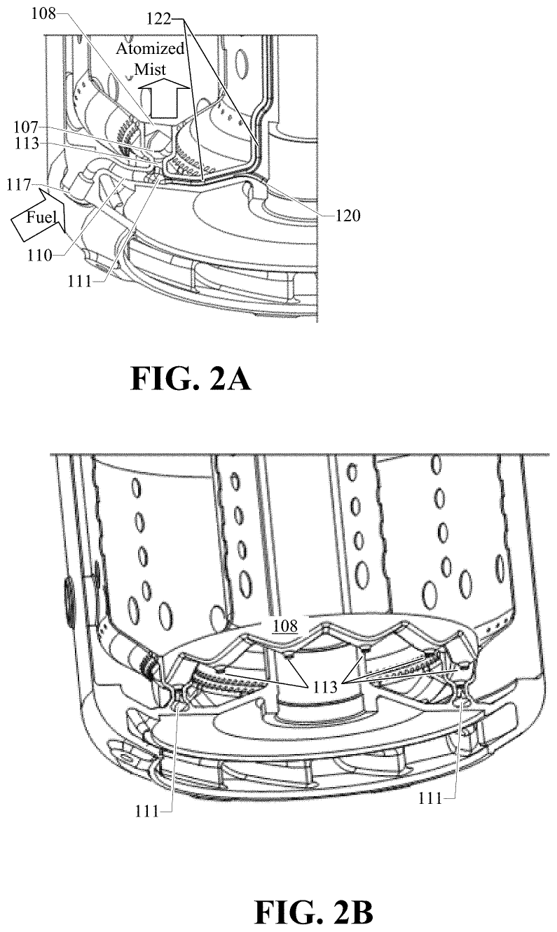

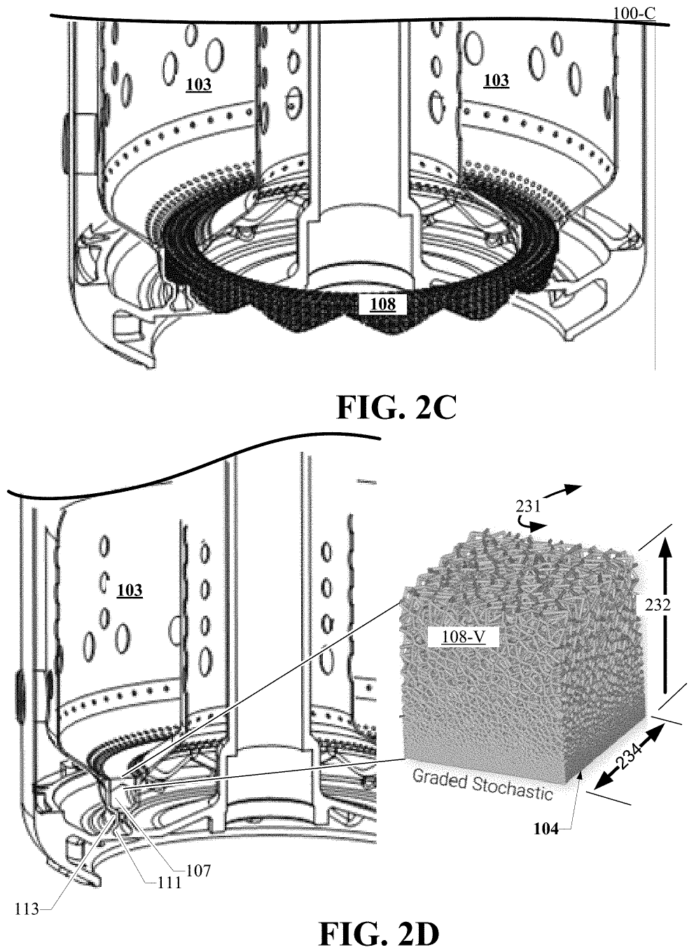

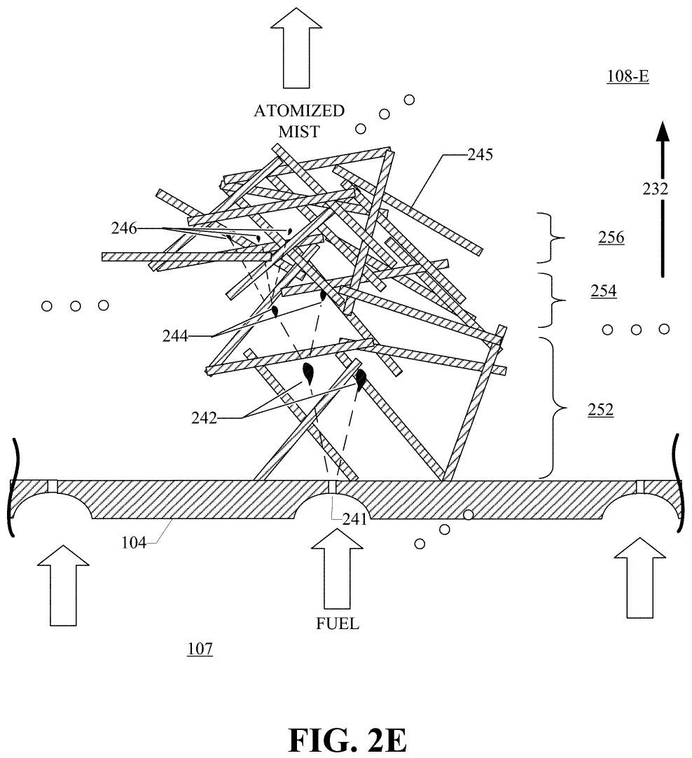

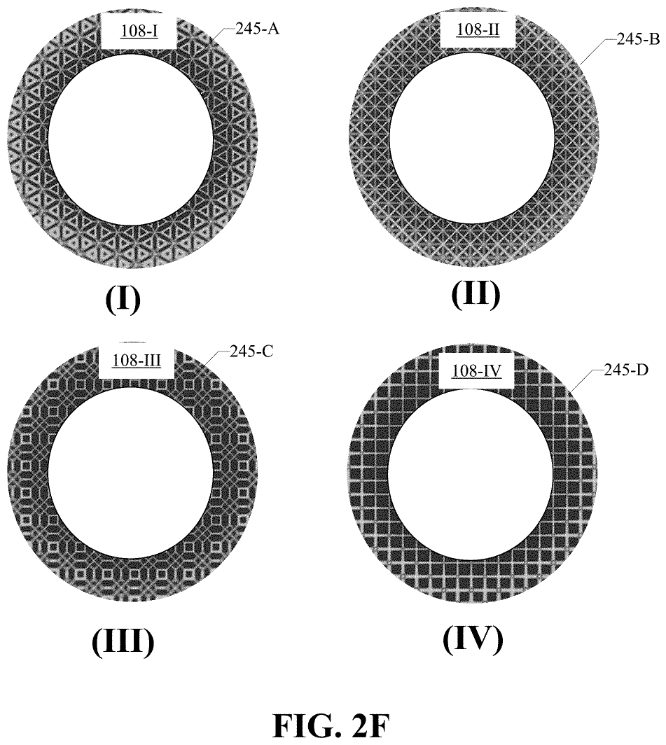

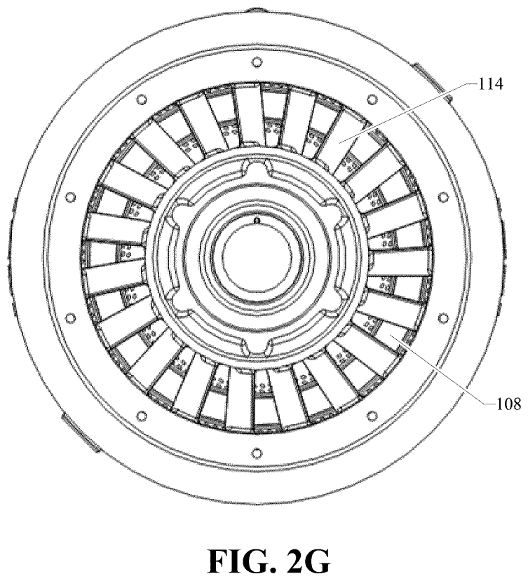

Referring now to FIG. 2A, a cutaway view is shown of a uni-body construction micro-turbine showing a fuel inlet 117, a fuel line passageway 110, a fuel supply rail 111, with fuel inlet ports, aka fuel distributors 113 leading to a fuel manifold 107 all with the function of delivering fuel to circumferential fuel injector, aka an injector ring, 108 which atomizes the fuel into the combustor, according to one or more embodiments. Fuel manifold 107 has a void in this embodiment to provide a reserve of fuel to pass thru fuel injector ring 108. These components or functions are 3D AM formed in the uni-body construction micro-turbine for reliability and durability. Besides delivery of fuel for combustion in the combustor, the aforementioned fuel lines also lead to a fuel-as-lubricant manifold 122 and a fuel-as-lubricant port 120 to lubricate bearings for the main shaft (shown in FIG. 1A).

Referring now to FIG. 2B, a cutaway view is shown of a uni-body construction micro-turbine showing a fuel feed rail 111 to inlet ports 113 of the circumferential injector ring, according to one or more embodiments. In this embodiment, the circumferential fuel injector 113 transfers fuel from circumferential fuel feed rail 111 to the fuel manifold 107, which stores a reservoir of fuel in this embodiment.

Referring now to FIG. 2C, a cutaway view is shown of a uni-body construction micro-turbine 100-C showing a circumferential injector ring 108, according to one or more embodiments. Uni-bodied micro-turbine 100-C comprising a combustor that utilizes the sweep characteristics of laser beam to create an injector ring 108 in situ. This annulus injector “ring of fire”, allows for highly efficient fuel droplet breakup and the mixing of air to maximize full combustion. In addition since fuel injector system 108 is made from the same high temperature material as the combustor, the destructive nature of hot cycle fatigue is minimized significantly compared to combustors using injectors of a lesser material grade and a separate assembly. In one embodiment, the combustor benefits from a continuous, circumferential, injector ring that does not require discrete individual injector nozzles. Rather, circumferential fuel injector 108 distributes fuel continuously and evenly through a 360-degree band at the front of the combustion chamber.

A design technique utilizes AM equipment with support-free capability to create ideal gas turbine topology. In AM equipment with limits on geometric angles, creating an ideal sight line from injectors to turbine inlet can be impossible within enclosed volumes. On a system that supports angles between 0 and 45 degrees, a self-supporting injector ring topology is attained.

Referring now to FIG. 2D, a cutaway section is shown of a uni-body construction micro-turbine with an enlarged detail view of graded stochastic lattice structure of the circumferential injector ring, according to one or more embodiments. In either embodiment, the multitude of fuel atomization pores, are geometrically spaced, graded, or oriented such that the spherical droplet velocity at the injector face is optimized to for the combustion cycle.

Specifically, the graded stochastic lattice 108-VI communicates fuel to strands of the circumferential injector ring that are more distant from face 104 in fuel manifold 107. The purpose of a grade stochastic is to provide more randomized fuel dispersion which can result in a smaller droplet size and more dispersion, which in turn leads to more mixing with incoming fresh air to produce a more efficient and thorough combustion of the fuel in the combustion chamber.

With AM, each strand can be tailored to be the same or different in terms of size and shape in terms of different quantity, location, orientation, and size of resultant passageways through he strands, based upon factors such as linear, circumferential, hydraulic, etc. distance of strand from fuel distributors 113 in order to provide a custom tailored fuel droplet size, dispersion, and supply to combustion chamber. Utilization of computation fluid dynamic (CFD) modeling of fuel flow, fuel dispersion, fuel droplet size together with incoming air velocity, swirl patterns, vectors, results in an optimized system in terms of both fuel and air delivery and mixing of the two. In the present embodiment, spacing of the stochastic lattice is graded to be coarser in an axial direction 232 toward the combustor (and away from fuel manifold 107). The present disclosure is well suited to grading in different directions and compound directions, such as radial 234, circumferential 231 and axial 232, and in terms of micro-turbine orientation and other operating factors, as proven by CFD or empirical testing.

Referring now to FIG. 2E, a cross-sectional side view is shown of a circumferential fuel injector 108-E with an inverse stochastic gradient of strands 245 for breaking up and atomizing fuel for combustor, according to one or more embodiments. It is an inverse gradient because it is an opposite gradient of that provided in prior FIG. 2E. Specifically, strands 245 are sparsely fabricated in 3D AM layer 252 closest to face 104 disposed on fuel manifold 107. Further in axial direction 232 towards combustor, density and orientation of strands 245 becomes more dense in layer 254 and finally in 256. Resultantly, fuel drops 242 sprayed from pores 241 in face 104 travels some distance, thereby gaining velocity before striking one or more strands 254 and breaking into smaller droplets 244, which in turn alter their trajectory and strike additional strands 246. The result is a finer atomized fuel that leads to combustion that is more thorough. Strands are manufactured simultaneously with other micro-turbine component features at a respective level in the 3D AM printing process.

Referring now to FIG. 2F, a top view is shown of four different exemplary patterns 108-I, 108-II, 108-III, and 108-IV formed by a wide variety of strand types and features, 245-A, 245-B, 245-C, and 245-D, respectively, in the circumferential injector ring matrix, according to one or more embodiments. Strands 245 can be arranged in a wide variety of patterns, density, gradients, etc. for a given jet petroleum (JP) fuel type, operating temperature, and additive properties. Strands 245 can be continuous, as shown in prior FIG. 2E, or can have random and protruding ends, shapes or edges for more effective atomization. Strands 245 contact each other and face 104 for support during 3D AM fabrication.

Referring now to FIG. 2G, a front view is shown looking into the exhaust of the uni-body construction micro-turbine, with portions of the circumferential injector ring matrix 108 visible between the nozzle guide vanes 114, according to one or more embodiments. By observing the consistent and evenly dispersed circumferential fuel injector 108, it is easy to understand why the combustor provides a very consistent and even flow of combusted gases out through NGV 114 without hot spots and thermal variations.

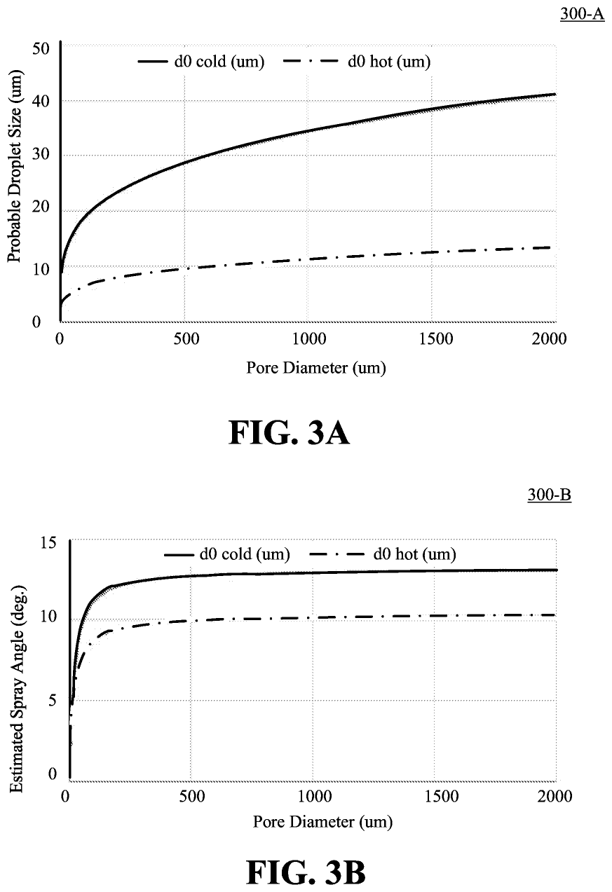

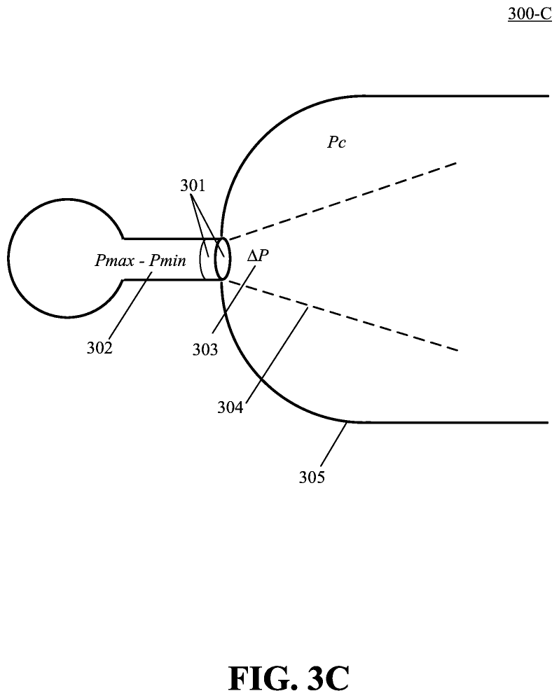

Referring now to FIG. 3A, a graph 300-A is shown of probable droplet size versus pore diameter at hot and cold temperatures, according to one or more embodiments. This is a representative relationship between pore diameter and estimated droplet diameter.

Calculations of the pore size and spacing for ideal atomization above the injector face to accommodate the combustion cycle, is modeled using the Sauter mean diameter and Weber number for the fluid in question.

Referring now to FIG. 3B, a graph is shown of estimated spray angle versus pore diameter, according to one or more embodiments. Assuming the length of the ‘nozzle’ is the depth of a single pore, and approximating that depth as ˜200 um (roughly five print layers), The Figure below presents the range of estimated spray angles.

The final component for design consideration is the estimated pressure drop per unit thickness through the injector material. This is estimated using the classic Darcy-Forchheimer relation for porous media flow. This is based on the provided fuel flow rate and a chosen injector cross-section area. The pressure drop per unit thickness is also a function of the fluid properties (μ, ρ) at each operating point and the specific porosity characteristics of the material. The pressure drop is related to the area of the injector and what pore size and density is desired. Pressure drop can be modeled using the Lattice Boltzmann Methods for multi phase flows:

Notes on calculations: 1. Smaller areas require higher pressure drop to reach mass flow requirements for the injector. 2. Fuel delivery pressure range for effective atomization. For given example, a range between 100 psi to 500 psi for fuel delivery pressure. 3. Pressure drop across the atomizer. Estimates are between 28-418 psi pressure drop depending on input parameters, but this can be modeled accurately with Lattice Boltzmann Methods. 4. What possible shapes and sizes of resulting atomized spray. The resulting shape will be cones with ˜12 degree angles from each of the pores, as the cones intersect there will be additional mixing. The pore geometry influences the droplet size, and so that can be varied as needed.

For the example given, the minimal impingement would be 0.3 mm above the injector face, e.g., as shown in detail view of FIG. 2.

Referring now to FIG. 3C, an example is provided for a 3D printed integral fuel atomizer. Atomizer outlet area 301 and atomizer volume dimensions are provided for integration into a CAD model. A fuel delivery pressure range 302 is needed for effective atomization throughout a required flow range. Next, a pressure drop 303 across the atomizer indicates a remaining pressure of atomized fuel in combustor. Finally, pattern 304 represents the possible shape and sizes of the resulting atomized spray.

To provide a first estimate of the fuel droplet size, a plain orifice spray atomization model is used. The Sauter Mean Diameter (SMD, d32) of the spray is calculated from a Weber number correlation for single-phase flow. Based on the provided fuel flow rate and temperature bounds (1016 cm³/s@−20° C. and 2105 cm³/s@100° C., per injector), a bounding range of density and velocity can be determined for a given flow area. The density ranges from ˜750-835 kg/m³, and for the current 2 mm diameter fuel port the injection velocity ranges from ˜323-670 m/s. Using the model from Equations 1-3, and assuming a surface tension of 0.03 N/m, this results in a probable droplet diameter range of 1.9-0.6 um, with the colder temperature fuel producing larger droplets.

For the same flow rates, the droplet size for a porous fuel injector will vary depending on the pore size, porosity percentage, and injector area. FIG. 3A shows a representative pair of curves showing the estimated droplet size vs. pore size for a 0.5 cm² (4 mm diameter) injector with 50% open porosity. In this case, due to the increased flow area, the velocity range is considerably lower at ˜41-84 m/s. Note that this is the expected pore velocity and takes into account the open porosity relative to the total injector area. According to research, optimal combustion appears to occur in the 20-80 um range, so the pores may provide improved combustion performance (which will require validation through testing).

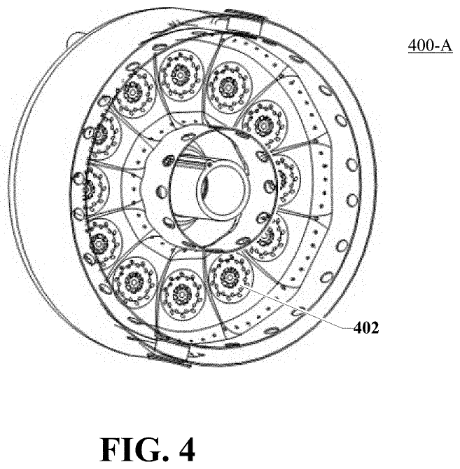

Referring now to FIG. 4, an isometric view is shown of equally evenly distributed and discrete fuel heads at a front of the combustion chamber, according to one or more embodiments. This embodiment can also be realized with the current AM uni-body construction micro-turbine. This embodiment injects fuel at equally spaced discrete points, for example at evenly distributed fuel head locations centered at a specific radius.

### Methods

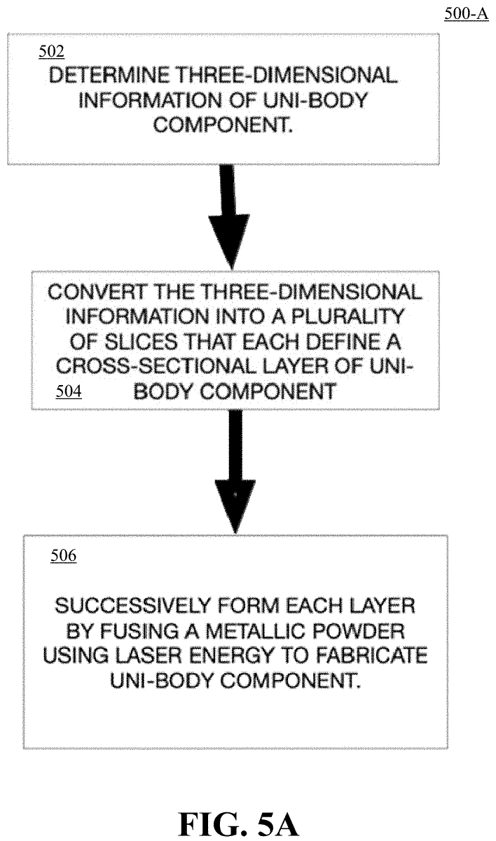

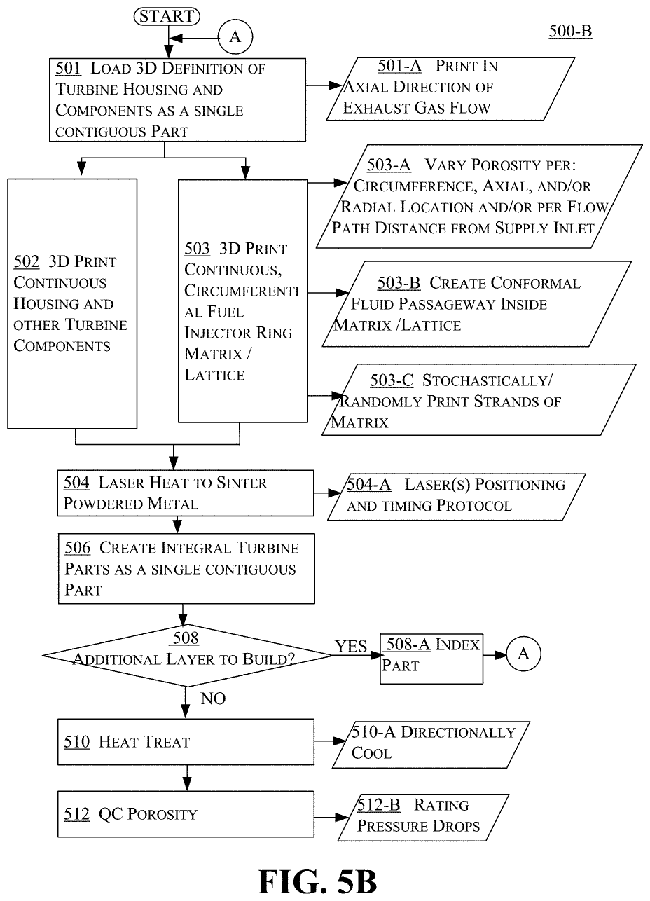

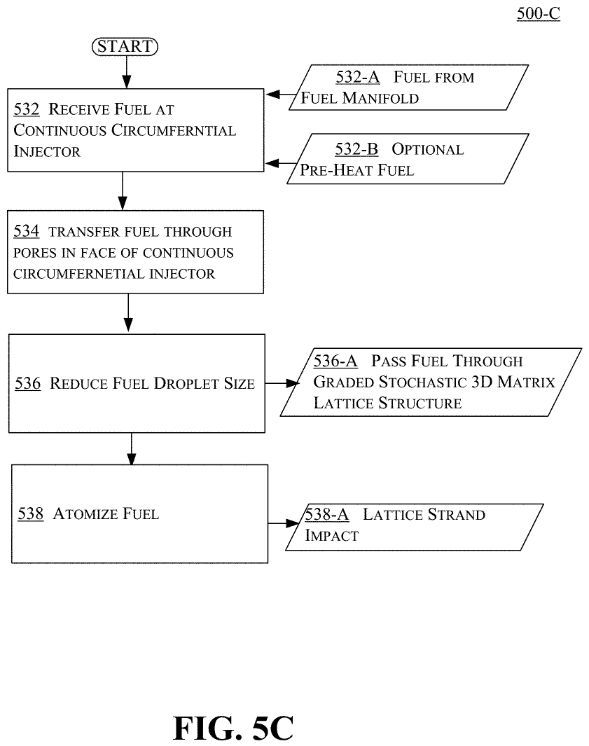

Referring now to FIG. 5A, a flowchart is shown of a process to translate an engineering design into an additive manufacturing operation for a uni-body construction micro-turbine, according to one or more embodiments. Operation 502 determines three-dimension information of a uni-body component, e.g., using computer assisted design (CAD) or other similar software. Operation 504 converts the three-dimensional information into plurality of slices that each defines a cross-sectional layer of uni-body components. Finally operation 506 successively forms each layer by fusing a metallic powder using laser energy to fabricate the uni-body component.

Referring now to FIG. 5B, a flowchart is shown of a process to manufacture a uni-body construction micro-turbine with a circumferential injector ring via additive manufacturing, according to one or more embodiments. In operation 501, load 3D definition of turbine housing and components as a single contiguous part, with an output of 501-A for printing in an axial direction of exhaust gas flow in one embodiment.

Operation 502 three-dimensionally (3D) prints continuous housing and other turbine components. In parallel, operation 502 3D prints a continuous, circumferential fuel injector ring matrix/lattice. Outputs include 503-a, which vary porosity per circumference, axial, and/or radial location and/or per flow path distance from supply inlet. Operation 503-b creates conformal fluid passageway inside matrix/lattice. Operation 503-c stochastically/randomly print strands of matrix, as shown in FIG. 2D.

In operation 504, laser heat sinters powdered metal, as controlled by output 504-a which directs laser(s) positioning and timing protocol

In operation 506, integral turbine parts are created as a single contiguous part. This operation has numerous benefits in terms of reduced manpower for assembly, and possible failure modes along assembly seams, split lines, and fastener points.

Operation 508, inquires whether there is an additional layer to build. If yes, then operation 508-A indexes the part in the direction shown in FIG. 1A, and proceeds to repeat the operations of 501 for 3D definition of the next layer of material to be formed in the single contiguous part.

Operation 510 heat-treats the finished product, with an optional embodiment of directional cooling to establish preferable grain structure, such as mono-crystalline grain structure. Other suitable grain structures and material properties can be implemented for thermal environment and strength requirements of the appropriate component in uni-body micro-turbine.

Finally, operation 512 performs a quality control (QC) evaluation and repairs on porosity size, location, and quality. The purpose is to achieve a desired output 512-B of meeting the rated pressure drops and atomization performance for fuel dispersion from the continuous, circumferential, injector ring.

Referring now to FIG. 5C, a flowchart is shown of a process to translate an engineering design into an additive manufacturing operation for a uni-body construction micro-turbine, according to one or more embodiments. Operations are implemented in components described in FIGS. 1A-4. A first operation 532 receives fuel at continuous circumferential injector, notably from fuel manifold 107 shown in FIGS. 1B and 2A. En route through fuel line passageway 110, fuel rail 111, and fuel manifold 107, operation 532-B can optionally pre-heating fuel for better atomization in circular fuel injector 108.

Next operation 534 transfers fuel through pores in face of continuous circumferential fuel injector 108. Surface 104 in FIG. 2D has microscopic pores from a graded stochastic lattice structure (pores not visible to the naked eye at bottom surface 104) in one embodiment, while FIG. 2E illustrates a more consistent and sized pore 241.

Operation 536 reduces fuel droplet size by passing fuel through a graded stochastic 3D matrix lattice structure per sub-operation 536-A. A wide variety of lattice structures can be used to reduce droplet size, with two such examples shown in FIGS. 2D-2E.

Finally operation 538 atomizes fuel, via lattice strand impact in sub-operation 538-A. Atomized fuel is injected in combustor 103 for ignition and burning. The atomization is consistent and even across a radius and a circumference of circumferential fuel injector because a discrete point fuel injector nozzle, or head, is not required in the present embodiment. Rather, the entire surface area of the circumferential fuel injector has a consistent porosity and lattice matrix that creates the effect of a toroidal distribution of atomized fuel, rather than a plurality of cylindrical ejection of atomized fuel from a round legacy fuel injector design.

### Alternatives

Methods and operations described herein can be in different sequences than the exemplary ones described herein, e.g., in a different order. Thus, one or more additional new operations may be inserted within the existing operations or one or more operations may be abbreviated or eliminated, according to a given application.

Other features of the present embodiments will be apparent from the accompanying drawings and from the detailed description. In addition, it will be appreciated that the various operations, processes, and methods disclosed herein may be carried out, at least in part, by processors and electrical user interface controls under the control of computer readable and computer executable instructions stored on a computer-usable storage medium. Such operations, processes, and methods include the three-dimensional information and control of the AM process to create a uni-bodied micro turbine engine.

The foregoing descriptions of specific embodiments of the present disclosure have been presented for purposes of illustration and description. They are not intended to be exhaustive or to limit the invention to the precise forms disclosed. Many modifications and variations are possible in light of the above teaching without departing from the broader spirit and scope of the various embodiments. The embodiments were chosen and described in order to explain the principles of the invention and its practical application best and thereby to enable others skilled in the art to best utilize the invention and various embodiments with various modifications as are suited to the particular use contemplated. It should be appreciated that embodiments, as described herein, can be utilized or implemented alone or in combination with one another. While the present disclosure has been described in particular embodiments, it should be appreciated that the present invention should not be construed as limited by such embodiments, but rather construed according to the claims appended hereto and their equivalents. The present invention is defined by the features of the appended claims.

We claim:

1. A turbine core comprising:
a single unibody part further comprising at least two static components of: a central bearing support structure, an outer casing, a combustor, a plurality of nozzle guide vanes (NGVs), a diffuser section, a diffuser outer casing, a fuel manifold, a circumferential fuel injector, an igniter mounting boss, a fuel-lubricating-manifold, a fuel-lubricating-port, or a turbine outer casing; and wherein:
the single unibody part does not require fastening hardware or welding processes to couple the at least two static components.

2. The turbine core of claim 1, wherein:
the single unibody part is created by a 3D additive manufacturing process.

3. The turbine core of claim 1, wherein:
at least one static component of the single unibody part has a different porosity inconsistent with at least a second static component of the single unibody part.

4. The turbine core of claim 1, wherein:
the combustor and the circumferential fuel injector are fabricated simultaneously with each other to form the single unibody part.

5. The turbine core of claim 1, wherein:
the combustor and the circumferential fuel injector are comprised of a same material.

6. The turbine core of claim 1, wherein:
the combustor is rigidly coupled to a front face and a rear face of the turbine core.

7. The turbine core of claim 1, wherein:
the single unibody part comprises all of the static components.

8. The turbine core of claim 1, wherein:
the circumferential fuel injector is formed as a microscopic lattice structure integral with the turbine core.

9. The turbine core of claim 1, wherein:
at least one of a fuel supply line and a fuel-lubricating manifold are co-formed in the single unibody part.

10. The turbine core of claim 1, wherein:
the turbine does not require a discrete injector to deliver fuel to the combustor.

11. The turbine core of claim 1, wherein:
the circumferential injector is comprised of:
a continuous circumferential face coupled to a pressurized fuel manifold; and wherein:
a plurality of pores formed radially and circumferentially within the continuous circumferential face communicates the fuel from a pressurized fuel manifold into the combustor.

12. The turbine core of claim 1, wherein:
the circumferential injector is comprised of:
a continuous matrix of latticed strands disposed in at least two of circumferential, radial, and axial dimensions; and wherein:
the latticed strands have a porosity to receive fuel from a high-pressure fuel manifold; and
the latticed strands atomize fuel dispensed from pore openings into the combustor.

13. The turbine core of claim 12, wherein:
the continuous matrix is a three-dimensional (3D) graded stochastic lattice structure.

14. A fuel injector for a turbine comprising:
a continuous circumferential face coupled to a pressurized fuel manifold; and wherein:
a plurality of pores formed radially and circumferentially within the continuous circumferential face that communicates the fuel from the pressurized fuel manifold into the combustor.

15. The fuel injector of claim 14, wherein:
the circumferential injector is further comprised of:
a continuous circumferential 3D matrix of latticed strands disposed axially from and coupled to the continuous circumferential face; and wherein:
the latticed strands atomize fuel dispensed from the pore openings in the continuous circumferential face.

16. The fuel injector of claim 14, wherein:
the continuous circumferential 3D matrix comprises a graded stochastic lattice structure.

17. A method of injecting a fuel into a combustor of a turbine, the method comprising:
receiving the fuel from a fuel manifold into a continuous circumferential injector; and
transferring the fuel through pores formed in the face of the continuous circumferential injector.

18. The method of claim 17, further comprising:
reducing a droplet size of the fuel by passing the fuel through a graded stochastic 3D matrix lattice structure formed as part of the continuous circumferential injector.

19. The method of claim 17, further comprising:
atomizing the fuel via the latticed strands after the fuel is dispensed from the continuously circumferential injector.

20. The method of claim 17, further comprising:
preheating the fuel in at least one of a fuel line passageway and a fuel supply rail integrally formed with a turbine housing.
